(19) United States
(12) Patent Application Publication
(10) Pub. No.: US 2026/0177093 A1
(43) Pub. Date: Jun. 25, 2026

(54) NON-CONDUCTIVE ADJUSTABLE CABLE GRIPPER

(71) Applicant: GOLDEN PEAKOCK OVERSEAS LIMITED, Noida, Uttar Pradesh (IN)

(72) Inventor: Rajan Kapoor, Noida, Uttar Pradesh (IN)

(21) Appl. No.: 18/730,441

(22) PCT Filed: Sep. 4, 2023
(86) PCT No.: PCT/IN2023/050832

§ 371 Date: Jul. 19, 2024

(30) Foreign Application Priority Data
Jul. 6, 2023 (IN) 202311045480

(51) Int. Cl. B25J 15/02; B25J 15/00; B25J 15/12

(52) U.S. Cl. CPC F16B 13/0891; F16G 11/108

(57) ABSTRACT

The present invention provides a non-conductive gripper for firmly holding a cable wire under suspension, or tensile stress, without resulting into electrical faults, such as short circuiting, due to stressed gripping of cable wire by internal parts of the gripper. The non-conductive gripper comprises internal parts, including gripping balls, made of non-conductive material, such as plastic. Therefore, even if the gripping balls cut through insulation of the cables wire under stress, the gripping balls, which are made of plastic, do not result in electrical faults.

### BACKGROUND OF INVENTION

The present invention is generally related to cable grippers. More particularly, the present invention relates to cable grippers for suspension lighting.

A gripper is a sophisticated piece of hardware that allows an electrician to adjust the height of a fixture without utilizing tools. As a cable slides through the gripper, a plunger and three balls within the gripper surround the outside diameter and catch the cable as it passes through the gripper. When mounted and weight is applied to the gripper, the tension forces the balls to grab the cable in a pinching movement.

In general, conventional single cable grippers have many applications in Cable/Wire suspension or making loops etc. But all existing cable grippers, including all the parts of the gripper, are made of metal, including metal type locking part, such as gripping ball etc. Using such metal grippers for two core/three core electric wire hanging is not sustainable and advantageous, because whenever a load is hanged using the grippers, the metal balls may cut through insulation of wire, which is usually plastic. Thus, such incidents may result in faults, such as short circuit, or breaking of wires, etc. Short circuiting of wires may occur because of metal type balls.

Therefore, there exists a need to develop a gripper for cable wires, where the gripper can firmly hold the cable wires, without cutting or distorting them under stress or tension, and without a risk of short circuit, or electrical hazards.

### OBJECTIVES OF THE INVENTION

It is an objective of the present invention to provide a gripper for a cable wire which can firmly hold a cable wire under tensile stress, without cutting or distorting them.

An objective of the present invention is to provide a gripper which can be used with a cable wire, reducing the chances of faults like, short circuiting, or breaking of wire or other electrical hazards.

An objective of the present invention is to provide a gripper of non-conductive material, which can hold a cable wire as firmly as a gripper of conductive material conventionally available.

### SUMMARY OF THE INVENTION

An aspect of the present invention includes a gripper for holding a cable wires under tension, comprising: a non-conductive body acting as a housing; a non-conductive spring-loaded plunger, inside the body, having: a central through hole along length of the plunger to insert one single electrical cable wire through it, and a plurality of holes, each hole holds at least one non-conductive gripping component for firmly gripping the single electrical cable wire, inserted through the central hole, under tensile stress, wherein all the gripping components are made of non-conductive material; wherein all the components of the gripper, including the body, the spring-loaded plunger, and the gripping components do not conduct electricity even when the single electrical cable wire is tampered under tension.

Another aspect of the present invention includes the gripper further comprising: a spring, situated under the spring-loaded plunger, for supporting up and down movement of the spring-loaded plunger caused whenever a load is applied and released on the single electrical cable wire; at least two non-conductive rings, situated around outer of the body, for holding the body when the gripper is holding the cable wire; and a non-conductive stopper that locks the spring and the plunger inside the body.

Another aspect of the present invention includes the gripper further comprising a non-conductive locking nut, situated around outer of the body and above the non-conductive plunger, for locking the non-conductive plunger at a locking position, when the single electrical cable wire is passed through the central hole of the non-conductive plunger and a load is applied on the single electrical cable wire to bring the single electrical cable wire under tensile stress, wherein the locking position of the non-conductive plunger is held and secured by the non-conductive locking nut.

An embodiment of the present invention includes the spring is of conductive material.

An embodiment of the present invention includes at least one of the at least two non-conductive rings has a knurled outer surface.

An embodiment of the present invention includes the plunger has at least 3-6 holes for holding the gripping components.

An embodiment of the present invention includes the gripper has at least 3-6 gripping components.

An embodiment of the present invention includes the non-conductive material is at least one of plastic or Teflon or rubber, or any combination thereof.

An embodiment of the present invention includes the gripping components have a shape which is at least one of a ball, semi-spherical, oval, trapezoidal, rectangular or square, or any combination thereof.

Another embodiment of the present invention includes the spring is tapered compression spring.

Yet another embodiment of the present invention includes the plunger is an oval plunger for gripping cable wires, and wherein the cable wires are flat wires.

An aspect of the invention provides the gripper implements the single electrical cable wire for electrical connection and for hanging an article as well, and no separate wire rope is inserted into the gripper for hanging an article

### BRIEF DESCRIPTION OF DRAWINGS

For a better understanding of the embodiments of the systems and methods described herein, and to show more clearly how they may be carried into effect, references will now be made, by way of example, to the accompanying drawings, wherein like reference numerals represent like elements/components throughout and wherein:

FIGS. 1-3 illustrate an exemplary environment showing an assembly of a gripper with two or three core wire, where FIG. 1 illustrates top view, FIG. 2 illustrates sectional perspective view and FIG. 3 illustrates a perspective view, in accordance with an embodiment of the present invention;

FIGS. 4-11 illustrate individual parts of the gripper and the cable wire, in accordance with an embodiment of the present invention; and

FIGS. 12-13 illustrate an exemplary environment showing an assembly of a gripper with two or three flat core wire, where FIG. 12 illustrates an assembled view,

FIG. 13 illustrates an additional plunger that can be used with the gripper of FIG. 12, in accordance with an embodiment of the present invention.

### DETAILED DESCRIPTION OF INVENTION

This patent describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention provides a cable gripper for gripping one single electrical cable wire under suspension. All the components of the gripper, including and not limited to, plunger, balls, rings, outer body, outer rings, stoppers, and others are made of non-conductive material so that electrical conductivity due to the gripped electrical cable wire is avoided. In an embodiment, the non-conductive material is plastic. In an embodiment, at least one component of the gripper is made of a conductive material, e.g., spring.

The non-conductive parts of the gripper do not damage the single electrical cable wire during locking and even if balls cut through the wire through insulation, the non-conductive parts do not cause any faults, such as short circuit etc. because of the non-conductive parts.

In the embodiment, where the spring is made of a conducting material, still the gripper would be non-conductive in nature, because electrical conductivity due to the gripped electrical cable wire is still avoided as the conductive spring part of the gripper is not in physical contact with the electrical cable wire that goes through the gripper, according to the invention.

According to an embodiment of the present invention, the gripper comprises a non-conductive body having a single tapered bore inside, wherein runs a tapered spring-loaded non-conductive plunger with a central hole and with radial holes.

In an embodiment, the body is cylindrical.

In an embodiment, the radial holes are 3-6 in number.

These radial holes hold non-conductive balls of appropriate size, such that when a cable wire moves along the tapered hole of the body under spring pressure, the non-conductive balls grip the cable wire pushed through the central hole of the plunger. In an embodiment, three-six numbers of balls are generally employed with three-six radial holes. It may be obvious to a person skilled in the art, that the gripper may have less or more number of radial holes, or balls, than 6 holes or balls, depending on the design and requirement of the gripper, without deviating from the meaning and scope of the present invention.

While the non-conductive balls grip the cable wire, the cable wire is firmly gripped under tension of the suspended cable. After assembly, the wire is easily released/adjusted by pressing the plunger. Further, the plunger can be locked in that gripping position by screwing a non-conductive locking ring on the plunger, thus preventing any accidental loosening of the grips. In an embodiment, the locking ring is positioned outside the body.

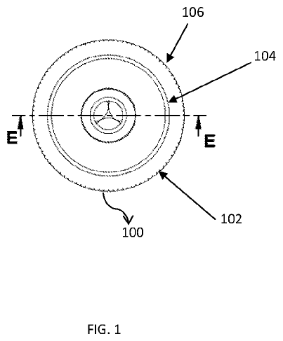

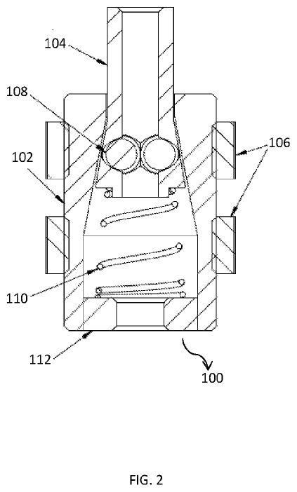

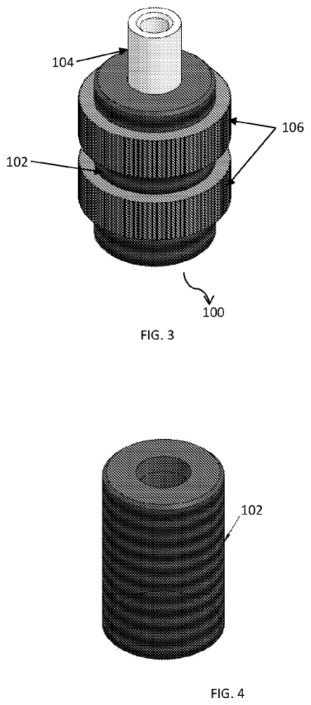

FIGS. 1-3 illustrate exemplary images showing a non-conductive gripper 100 where FIG. 1 illustrates a top view of the non-conductive gripper 100, FIG. 2 illustrates sectional perspective view of the non-conductive gripper 100 and FIG. 3 illustrates a perspective view of the non-conductive gripper 100, in accordance with an embodiment of the present invention. As explained above the non-conductive gripper 100 holds a single electrical cable wire.

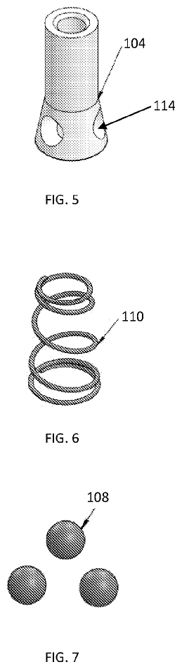

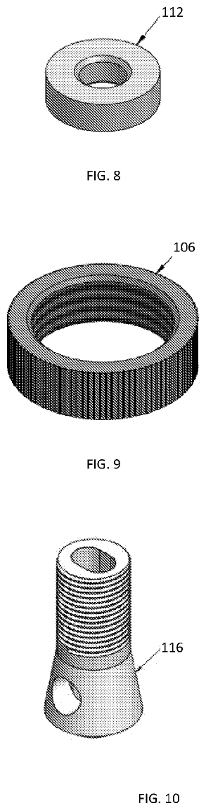

FIGS. 4-9 shows exemplary images of the components that are included in the gripper 100. FIG. 4 shows an exemplary image of a non-conductive body 102. FIG. 5 an exemplary image of a non-conductive plunger 104 with a plurality of holes 114. FIG. 6 shows an exemplary image of a spring 110. FIG. 7 shows an exemplary image of non-conductive gripping components 108, e.g., gripping balls. FIG. 8 shows an exemplary image of a non-conductive stopper 112. FIG. 9 shows an exemplary image of a non-conductive ring 106.

Referring to the FIGS. 1-9 shows a non-conductive gripper 100 for holding a conductive cable wire under tension, comprising: a non-conductive body 102 acting as a housing; a spring-loaded tapered non-conductive plunger 104, inside the body 102, having: a central through hole along length of the plunger 104 to insert the cable wire through it, and a plurality of holes 114, each hole 114 holds at least one non-conductive gripping ball 108 for firmly gripping the conductive cable wire, inserted through the central hole, under tensile stress, wherein the gripping balls 108 are made of non-conductive material; a spring 110, situated under the non-conductive plunger 104, for supporting up and down movement of the plunger 104 caused whenever a load is applied and released on the cable wire; at least two non-conductive rings 106, situated around outer of the body, for holding the body 102 when the gripper is holding the cable wire. In an embodiment, the non-conductive rings 106 may have knurling surface for proving better gripping of user.

In an embodiment, for additional safety, the gripper 100 may also include a non-conductive locking nut, situated around outer of the body and above the plunger 104, for locking the plunger 104 at a locking position, when the cable wire is passed through the central hole of the plunger 104 and a load is applied on the cable wire to bring the cable wire under tensile stress, wherein the locking position of the plunger is held and secured by the locking nut.

It should be noted, that the non-conductive gripper 100 grips only one single conductive electrical cable wire, that conducts electricity as well as hangs an article also. No separate wire rope goes through the gripper 100 and is gripped by it for hanging the article.

The non-conductive gripper 100 includes a non-conductive main body 102. The main body 102 is a housing for sub parts or internal parts of the gripper 100. In an alternate embodiment, the main body 102 may have tapered angle inside the body and thus, the main body 102 plays a very important role for gripping a cable or a wire due to presence of tapered angle inside the body 102. The gripper 100 further includes a non-conductive plunger 104 that has plurality of cavities/holes 114 to carry multiple non-conductive gripping balls 108 for wire fixing. Each cavity 114 in the plunger 104 may carry at least one gripping component 108, e.g., one gripping ball 108.

In an embodiment, the gripper 100 may have three-six gripping balls 108. The gripping balls 108 are made of non-conductive material. In an embodiment, the non-conductive material is plastic. The gripping balls 108 are critical component of the gripper 100 acting as a grip lock for a wire and the wire doesn't get slip under tension. The gripping balls 108 firmly hold the cable wire under tensile stress. It may be apparent to a person skilled in the art, that the plunger 104 may also carry differently shaped gripping components instead of the gripping balls 108, such that these gripping components are suitable to be carried in the plunger and are successful in firmly gripping the cable wire under tensile stress for example may be semi-spherical, or oval, or trapezoidal, or rectangular or square, without deviating from the meaning and scope of the present invention.

The gripper 100 further comprises a spring 110 under the plunger 104. In an embodiment, the spring 110 may be a type of tapered compression spring which helps moving the plunger 104 up and down by applying little downward force on the plunger 104 and the spring 110 returns back after releasing the loaded force, on the cable, to get at its initial position. The gripper 100 includes a non-conductive washer/stopper 112, and the stopper 112 locks spring 110 and plunger 104 inside the main body 102.

Furthermore, the gripper 100 includes at least two non-conductive rings 106 on its body 102. At least one of the rings 106 may have a knurled surface; the rings 106 hold the main body 102 during usage of the gripper 100 with lighting parts, such as a pendant lighting. Additionally, the rings 106 may also provide a better grip for a user holding the gripper 100.

In an embodiment, the gripper 100 may also include a non-conductive locking nut for additional safety, which locks the plunger 104 at a locking position, when the wire is passed through the plunger 104 and a load is applied on the wire. At this time, position of the plunger 104 is tightened by the help of the locking nut.

The gripper 100 holds a single electrical cable that may have two or three cores, which is covered with a non-conductive insulation.

According to another embodiment, as shown in FIG. 10, the gripper 100 may include a non-conductive oval plunger 116 for gripping cable wire. In an embodiment, the wire is a flat wire.

The gripper 100 shown in the FIGS. 1-10 has all the internal components or parts made of non-conductive material. In an embodiment, at least all those internal components or parts are made of non-conductive material which are in direct physical contact with the electrical cable wire, or which are in indirect contact with the wire, such that they can cause electrical hazards. Thus, the gripper 100 has a non-conductive nature. The gripper 100 is adjustable around the cables. The non-conductive nature of the gripper does not damage the single electrical cable wire during locking. For example, even if, the balls cut through the insulation of the cable wires under tensile stress, the balls 108 do not cause any faults, such as short circuiting, because of non-conductive material of the balls 108. It may be obvious to a person skilled in the art that the internal components, such as balls 108 of the gripper 100, may be made of other non-conductive material present in the market, than plastic, such as rubber, Teflon, and the like, without deviating from the meaning and scope of the present invention.

Further, the gripper 100 includes the plunger 104 which is simple in design and adjustable using a screw for easily gripping the cable/cord/wire. Furthermore, in an embodiment, the oval plunger 116 may be used for flat cable/cord with 2-4 balls for gripping the cable/cord.

Advantageously, the gripper of the present invention, made of non-conductive material may be more particularly used for suspension lighting. The gripper may be easily fitted in quick, easy, convenient and cost-effective way for various fitments of pendants lighting, thus save assembly time and associated costs.

While certain embodiments have been described, these embodiments have been presented by way of example only, and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure.

1) A gripper for holding a cable wire under tension, comprising:
a non-conductive body acting as a housing;
a non-conductive spring-loaded plunger, inside the body, having:
a central through hole along length of the plunger to insert one single electrical cable wire through it, and
a plurality of holes, each hole holds at least one non-conductive gripping component for firmly gripping the single electrical cable wire, inserted through the central hole, under tensile stress, wherein all the gripping components are made of non-conductive material;
wherein all the components of the gripper, including the body, the spring-loaded plunger, and the gripping components do not conduct electricity even when the single electrical cable wire is tampered under tension.

2) The gripper of claim 1, wherein the gripper further comprising:
a spring, situated under the spring-loaded plunger, for supporting up and down movement of the spring-loaded plunger caused whenever a load is applied and released on the single electrical cable wire;
at least two non-conductive rings, situated around outer of the body, for holding the body when the gripper is holding the cable wire; and
a non-conductive stopper that locks the spring and the plunger inside the body.

3) The gripper of claim 2, wherein the gripper further comprising a non-conductive locking nut, situated around outer of the body and above the non-conductive plunger, for locking the non-conductive plunger at a locking position, when the single electrical cable wire is passed through the central hole of the non-conductive plunger and a load is applied on the single electrical cable wire to bring the single electrical cable wire under tensile stress, wherein the locking position of the non-conductive plunger is held and secured by the non-conductive locking nut.

4) The gripper of claim 2, wherein the spring is of conductive material.

5) The gripper of claim 2, wherein at least one of the at least two non-conductive rings has a knurled outer surface.

6) The gripper of claim 1, wherein the plunger has at least 3-6 holes for holding the gripping components.

7) The gripper of claim 6, wherein the gripper has at least 3-6 gripping components.

8) The gripper of claim 1, wherein the non-conductive material is at least one of plastic or Teflon or rubber, or any combination thereof.

9) The gripper of claim 1, wherein the gripping components have a shape which is at least one of a ball, semi-spherical, oval, trapezoidal, rectangular or square, or any combination thereof.

10) The gripper of claim 2, wherein the spring is tapered compression spring.

11) The gripper of claim 2, wherein the plunger is an oval plunger for gripping cable wires, and wherein the cable wires are flat wires.

12) The gripper of claim 1, wherein the gripper implements the single electrical cable wire for electrical connection and for hanging an article as well, and no separate wire rope is inserted into the gripper for hanging an article.
